(19) United States
(12) Patent Application Publication
(10) Pub. No.: US 2021/0182743 A1
(43) Pub. Date: Jun. 17, 2021

(54) System and Method for Procuring a Reservation Within a Heterogeneous Transportation Network

(71) Applicant: The James C. Paris Company, Dallas, TX (US)

(72) Inventor: James C. Paris, Dallas, TX (US)

(21) Appl. No.: 17/119,287

(22) Filed: Dec. 11, 2020

Related U.S. Application Data
(60) Provisional application No. 62/947,607, filed on Dec. 13, 2019.

(51) Int. Cl. G06Q 10/02

(52) U.S. Cl. CPC G06Q 10/02; G06Q 2240/00

(57) ABSTRACT

A system and method for procuring a reservation within a heterogeneous transportation network are disclosed. In one embodiment of the system, a database stores information for various transportation modes forming multiple transportation routes within the heterogeneous transportation network. For each fee collecting entity along the multiple transportation routes and for the various transportation modes, the database has an attribute including GIS data defining a virtual perimeter for a real-world geographic area corresponding to the fee collecting entity, an attribute including a valueless coefficient defining a payment term for the fee collecting entity, and an attribute including a value-based coefficient defining a payment basis for the fee collecting entity. The system determines a fee due to the fee collecting entities based on the three attributes.

### PRIORITY STATEMENT

This application claims priority from U.S. Application Ser. No. 62/947,607 entitled “System and Method for Procuring a Reservation within a Heterogeneous Transportation Network” and filed on Dec. 13, 2019 in the name of James C. Paris; which is hereby incorporated by reference, in entirety, for all purposes.

### TECHNICAL FIELD OF THE INVENTION

This invention relates, in general, to procuring a reservation and, in particular, to procuring a reservation within a heterogeneous transportation network, including multiple modes of transportation, requiring coordinating many distinct arrangements for a single itinerary.

### BACKGROUND OF THE INVENTION

Transportation is becoming increasingly complex. It is now common for travelers to need reservations across a heterogeneous transportation network, including multiple modes of transportation, through varying juristic boundaries. Travelers desire a platform that is accessible from anywhere and at any time to make these reservations. Travelers also prefer a single reservation purchase. Existing platforms, however, have proven cumbersome and the process of distributing payments and fees across the heterogeneous transportation network has proven difficult when a traveler makes a single reservation. Accordingly, there is a need for improved systems and methods for procuring reservations within a heterogeneous transportation network, including multiple modes of transportation, requiring coordinating many distinct arrangements for a single itinerary.

### SUMMARY OF THE INVENTION

It would be advantageous to introduce systems and methods that further procure reservations within a heterogeneous transportation network, including multiple modes of transportation, requiring coordinating many distinct arrangements for a single itinerary. It would also be desirable to enable a computer-based solution that would improve the quality and quantity of information about reservations for single itinerary through varying juristic boundaries. To better address one or more of these concerns, a system and method for procuring a reservation within a heterogeneous transportation network is disclosed. In one embodiment of the system, a database stores information for various transportation modes forming multiple transportation routes within the heterogeneous transportation network. For each fee collecting entity along the multiple transportation routes and for the various transportation modes, the database has an attribute including GIS data defining a virtual perimeter for a real-world geographic area corresponding to the fee collecting entity, an attribute including a valueless coefficient defining a payment term for the fee collecting entity, and an attribute including a value-based coefficient defining a payment basis for the fee collecting entity. The system determines a fee due to the fee collecting entities based on the three attributes. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a schematic diagram depicting one embodiment of a system for procuring a reservation within a heterogeneous transportation network, according to the teachings presented herein;

FIG. 2 is a successive conceptual grid diagrams depicting one embodiment of the operations of the system shown in FIG. 1;

FIG. 3 is a functional block diagram depicting one embodiment of a server presented in FIG. 1;

FIG. 4 is a conceptual module diagram depicting a software architecture of a reservation application of some embodiments;

FIG. 5 is a conceptual module diagram depicting a software architecture of an accounting application of some embodiments;

FIG. 6 is a flow chart depicting one embodiment of a method for procuring a reservation within a heterogeneous transportation network, according to the teachings presented herein; and

FIG. 7 is a schematic diagram depicting the heterogeneous transportation network shown in FIG. 1 in additional detail.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

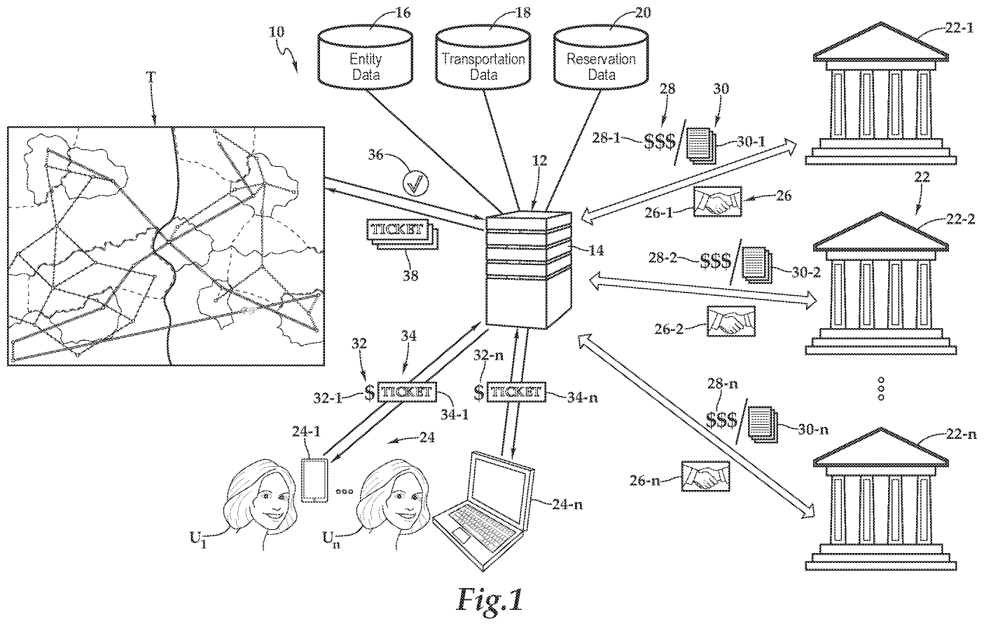

Referring initially to FIG. 1, a system 10 for procuring a reservation within a heterogenous transportation network T. The heterogeneous transportation network T includes multiple transportation modes forming many transportation routes. The transportation modes may include high-speed rail, light rail, streetcar, transportation-for-hire, autonomous vehicles (including unmanned autonomous vehicles and autonomous vehicles with pilots), semi-autonomous vehicles, bus, and the like. Autonomous vehicles and semi-autonomous vehicles include those with on-ground and off-ground effects. The autonomous vehicles, semi-autonomous vehicles, as well as other vehicles utilizing airspace, may include Automatic Dependent Surveillance-Broadcast (ADS-B) systems, which represent a surveillance technology in which an aircraft determines its position via satellite navigation or other sensors and periodically broadcasts it, enabling it to be tracked. Information may be received by air traffic control ground stations as a replacement or supplement for secondary surveillance radar, as no interrogation signal is needed from the ground. The information may also be received by other aircraft to provide situational awareness and allow self-separation.

A server 12, which includes a housing 14, has access to an entity database 16, a transportation database 18, and a reservation database 20. The server 12 is connected via the Internet or other network connection to various fee collecting entities 22 and computing devices 24. The fee collecting entities 22, which are individually labeled 22-1, 22-2, . . . , 22-n, are juristic or governmental entities, for example, that have a financial interest by way of a fee collection, including a tax, for the operation of the heterogeneous transportation network T within a boundary of the fee collecting entity. An operator of the server 12 and the fee collecting entities 22 have the fee arrangements defined by agreements 26. By way of example, agreement 26-1 is between the fee collecting entity 22-1 and the operator of the server 12, agreement 26-2 is between the fee collecting entity 22-2 and the operator of the server 12, and agreement 26-n is between the fee collecting entity 22-n and the operator of the server 12. As a result of these agreements 26, the operator of the server 12 pays fees 28 to the various fee collecting entities. By way of example, fee 28-1 is between the fee collecting entity 22-1 and the operator of the server 12, fee 28-2 is between the fee collecting entity 22-2 and the operator of the server 12, and fee 28-n is between the fee collecting entity 22-n and the operator of the server 12. Reports 30 may document the fees paid to the fee collecting entities 22-n by the operator of the server 12. By way of example, report 30-1 is between the fee collecting entity 22-1 and the operator of the server 12, report 30-2 is between the fee collecting entity 22-2 and the operator of the server 12, and report 30-n is between the fee collecting entity 22-n and the operator of the server 12.

Users U₁ . . . Uₙ respectfully utilize computing devices 24-1 . . . 24-n to communicate with the server 12 and make reservations for travel within the heterogeneous transportation network T. As shown, funds 32 are exchanged for transportation reservations 34. More particularly, with respect to the user U₁, funds 32-1 are exchanged for transportation reservation 34-1 and, with respect to user Uₙ, funds 32-n are exchanged for transportation reservation 34-n. The server 12 may furnish a user interface module that provides a user interface for the computing devices 24. The user interface provides functionality for a user, such as user U₁ or user Uₙ, to at least browse reservation information within the heterogeneous transportation network T and select a transportation reservation 34. The server 12 then communicates with the heterogeneous transportation network T to verify reservations and provide reservation information as shown by verification 36 and reservation information 38.

In one operational embodiment, the entity database 16 and the transportation database 18 within the server 12, which is a computer data storage device, stores and organizes information for the multiple transportation modes within the heterogeneous transportation network T. The various transportation modes form multiple transportation routes. The information being organized within the entity database 16 and the transportation database 18 is stored in accordance with a logical data model that includes the information about the fee collecting entities 22, and relationships defining the manner in which the information is stored and organized in the logical data model including, for each of the fee collecting entities 22 for each of the transportation modes various attributes, which are utilized to determine the fee or fees due to the fee collecting entities 22. With each reservation made and verified, the system 10 determines the fees due. More particularly, by way of example, the server 12 receives confirmation of the transportation reservation 34-1 including at least one of the transportation routes within the heterogenous transportation network T. The server 12 then accesses the computer data storage device for access to the entity database 16, the transportation database 18, and the reservation database 20. For each of the fee collecting entities 22 for the transportation reservation 34-1, fees 28 due to each one of the fee collecting entities 22 is determined.

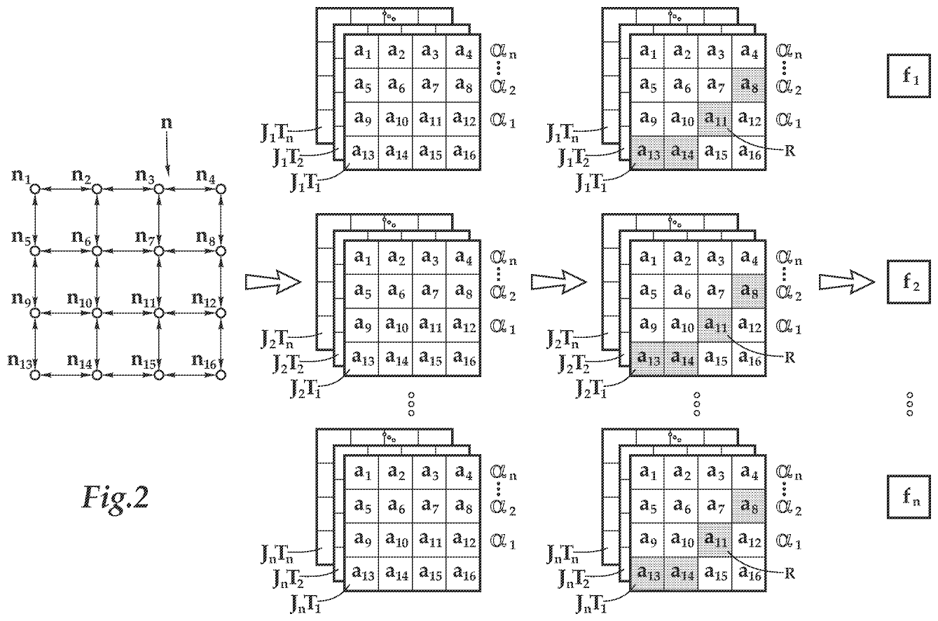

Referring now to FIG. 2, successive conceptual grid diagrams depict some embodiments of the operations of the system 10. The heterogeneous transportation network T is represented by a network flow model n, where various origins, destinations, and intermediate points are labeled as nodes, n₁, n₂, n₃, n₄, n₅, n₆, n₇, n₈, n₉, n₁₀, n₁₁, n₁₂, n₁₃, n₁₄, n₁₅, n₁₆, with transportation links or arcs interconnecting the nodes n₁-n₁₆. A GIS-based attribute that includes GIS data defining a virtual perimeter for a real-world geographic area corresponding to the various fee collecting entities 22 is utilized to create the network flow model n. In one implementation, nodal data represents passenger exchange locations for the various modes of transportation as individual nodes n₁-n₁₆, such as high-speed rail, light rail, streetcar, transportation-for-hire, autonomous vehicle, semi-autonomous vehicle, and bus, for example, with the arcs being the transportation lines.

Once the network flow model n is created, the various types of fees 28 potentially collected by the fee collecting entities 22 are combined into a comprehensive measure that permits measuring anywhere through the space. As shown, the cost surface is modeled as a series of raster grids. Each of the cells within a raster grid may correspond to one of the nodes n₁-n₁₆. A second attribute includes a valueless coefficient, a₁, a₂, a₃, a₄, as, a₆, a₇, a₈, a₉, a₁₀, a₁₁, a₁₂, a₁₃, a₁₄, a₁₅, a₁₆, defining a payment term for the fee collecting entity. The valueless coefficient, a₁, a₂, a₃, a₄, a₅, a₆, a₇, a₈, a₉, a₁₀, a₁₁, a₁₂, a₁₃, a₁₄, a₁₅, a₁₆, may a value relative to a sales tax, a property tax, or a transaction payment, for example.

For each fee collecting entity, J₁ . . . Jₙ, for each mode of transportation, T₁ . . . Tₙ, a raster grid is populated with the valueless coefficient a₁ . . . a₁₆ with a third attribute, α₁ . . . αₙ, including a value-based coefficient defining a payment basis for the fee collecting entity and acting as a mathematical weight for the raster grid. The value-based coefficient may be a ticket price or property value, for example. Once a transportation reservation 34 is made and verified, then a corresponding transportation route R is determined through the raster grids J₁T₁ . . . J₁Tₙ, J₂T₁ . . . J₂Tₙ, . . . JₙT₁ . . . JₙTₙ such that the fee due for the fee collecting entity J₁ is f₁, the fee collecting entity J₂ is f₂, and the fee collecting entity Jₙ is fₙ and, more specifically:

f₁=J₁T₁[(a₁₃+a₁₄+a₁₁+a₈)*α₁]+J₁T₂[(a₁₃+a₁₄+a₁₁+a₈)*α₂]+ . . . JₙTₙ[(a₁₃+a₁₄+a₁₁+a₈)*αₙ]

f₂=J₁T₁[(a₁₃+a₁₄+a₁₁+a₈)*α₁]+J₁T₂[(a₁₃+a₁₄+a₁₁+a₈)*α₂]+ . . . JₙTₙ[(a₁₃+a₁₄+a₁₁+a₈)*αₙ]

fₙ=J₁T₁[(a₁₃+a₁₄+a₁₁+a₈)*α₁]+J₁T₂[(a₁₃+a₁₄+a₁₁+a₈)*α₂]+ . . . JₙTₙ[(a₁₃+a₁₄+a₁₁+a₈)*αₙ]

Referring now to FIG. 3, one embodiment of the server 12 as a computing device includes a processor 50, memory 52, storage 54, inputs 56, outputs 58, and a network adaptor 60 interconnected with various buses 62 in a common or distributed, for example, mounting architecture. In other implementations, in the computing device, multiple processors and/or multiple buses may be used, as appropriate, along with multiple memories and types of memory. Further still, in other implementations, multiple computing devices may be provided and operations distributed therebetween. The processor 50 may process instructions for execution within the server 12, including instructions stored in the memory 52 or in storage 54, one or both of which may be non-transitory memory. The memory 52 stores information within the computing device. In one implementation, the memory 52 is a volatile memory unit or units. In another implementation, the memory is a non-volatile memory unit or units. Storage 54 includes capacity that is capable of providing mass storage for the server 12. Various inputs 56 and outputs 58 provide connections to and from the server 12, wherein the inputs 56 are the signals or data received by the server 12, and the outputs 58 are the signals or data sent from the server 12. The network adaptor 60 couples the server 12 to a network such that the server 12 may be part of a network of computers, a local area network (LAN), a wide area network (WAN), an intranet, a network of networks, or the Internet, for example.

The memory 52 and storage 54 are accessible to the processor 50 and include processor-executable instructions that, when executed, cause the processor 50 to execute a series of operations. A combination of the memory 52 and the storage 54 may include a database for storing and organizing information for various transportation modes, T₁ . . . Tₙ, within the heterogeneous transportation network T. As previously discussed, the various transportation modes, T₁ . . . Tₙ, form multiple transportation routes R. The information is organized within the database in accordance with a logical data model that includes information about the fee collecting entities 22. The logical data model includes relationships defining the manner in which the information is stored and organized in the logical data model including, for each of the fee collecting entities 22 for each of the transportation modes, T₁ . . . Tₙ, various attributes. In some embodiments, the attributes include the GIS-based attribute having GIS data defining a virtual perimeter for a real-world geographic area corresponding to the fee collecting entity, J₁ . . . Jₙ. The valueless coefficient, another attribute, includes a valueless coefficient, a₁ . . . a₁₆, defining the payment term for the fee collecting entity, J₁ . . . Jₙ. The value-based coefficient, α₁ . . . αₙ, defines the payment basis for the fee collecting entity, J₁ . . . Jₙ.

In one embodiment, the processor-executable instructions cause the processor 50 to receive confirmation of the transportation reservation 34 including at least one of the transportation routes R. The processor 50 is then caused to access the computer data storage device and create a network flow model based on the GIS-based attribute. In some embodiments, the processor-executable instructions then cause the processor 50 to create a cost surface having multiple cells. The cellular structure relates to the network flow model. The cost surface may have a value in each of the cells relative to the valueless coefficient, a₁ . . . a₁₆, and a weight associated with each of the plurality of cells relative to the value-based coefficient, α₁ . . . αₙ. The processor 50 is then caused by the processor-executable instructions to perform a non-optimized cost path analysis using cartographic modeling on the cost surface reflecting the transportation reservation 34. It should be appreciated that the non-optimized cost path analysis may include a non-optimized cost distance analysis as well. The fees 28 due to the fee collecting entity, J₁ . . . Jₙ, or fee collecting entities 22 are then determined.

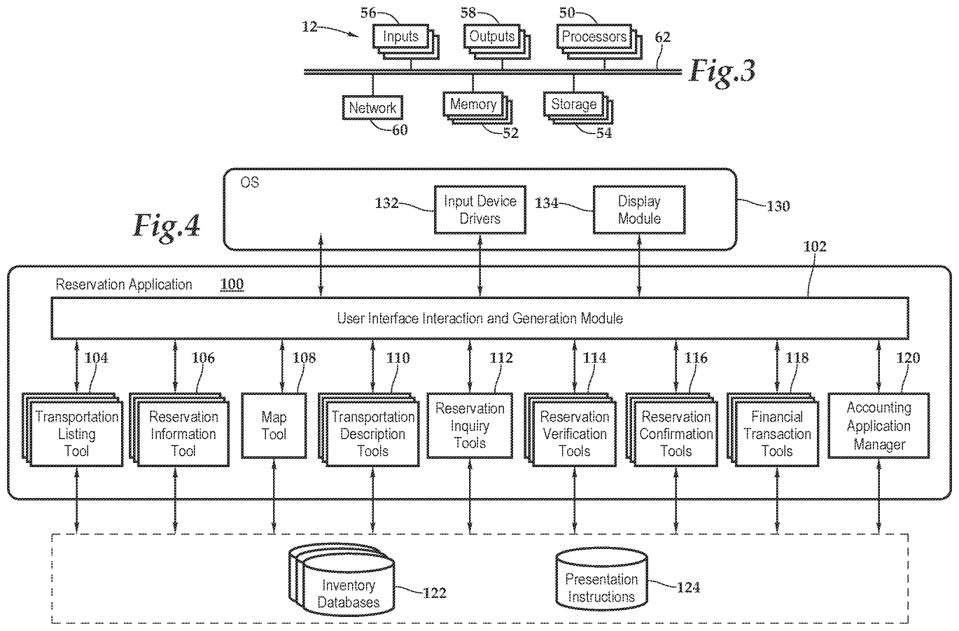

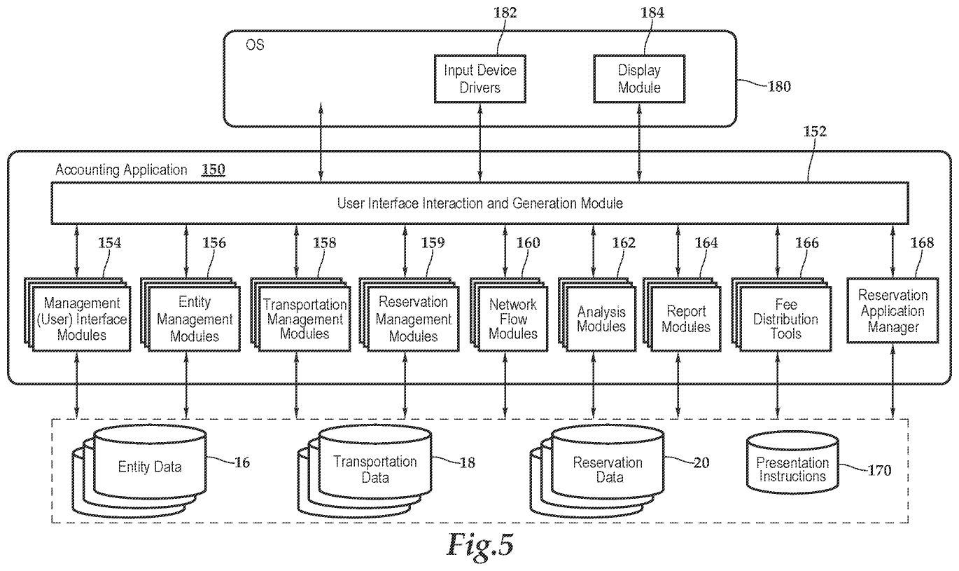

FIG. 4 conceptually illustrates the software architecture of a reservation application 100 of some embodiments that may make the arrangements and accommodations for a travel reservation within the heterogeneous transportation network T having multiple transportation modes, T₁ . . . Tₙ, and multiple transportation routes R. In some embodiments, the reservation application 100 is a stand-alone application or is integrated into another application, while in other embodiments the application might be implemented within an operating system. Furthermore, in some embodiments, the reservation application 100 is provided as part of a server-based solution or a cloud-based solution. In some such embodiments, the application is provided via a thin client. That is, the application runs on a server while a user interacts with the application via a separate machine remote from the server. In other such embodiments, the application is provided via a thick client. That is, the application is distributed from the server to the client machine and runs on the client machine.

The reservation application 100 includes a user interface (UI) interaction and generation module 102, a transportation listing tool 104, a reservation information tool 106, map tool 108, transportation description tools 110, reservation inquiry tools 112, reservation verification tools 114, reservation confirmation tools 116, financial transaction tools 118, and an accounting application manager 120. The reservation application 100 has access to inventory databases 122 and presentation instructions 124. The inventory databases 122 include information about travel accommodation availability, price, reservation availability, travel descriptions, and travel routes, for example. The presentation instructions 124 store the user presentation editing operations that the reservation application 100 performs as a set of instructions. In some embodiments, the inventory databases 122 and the presentation instructions 124 are all stored in one physical storage. In other embodiments, the storages represented by the inventory databases 122 and the presentation instructions 124 are all stored in separate physical storages, or one of the storages is in one physical storage while the other is in a different physical storage.

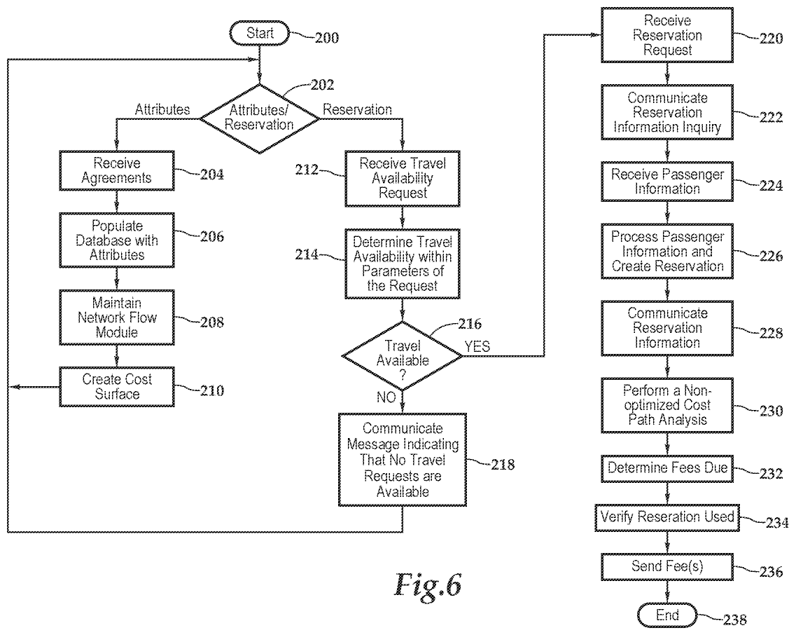

The transportation listing tool 104 accesses the inventory databases 122 to create a travel listing in response to a search by a user, such as a passenger. The reservation information tool 106 may provide the travel listings with availability and reservation information. The map tool 108 augments the travel listing with information about the route that may presented as an annotated map, for example. The transportation description tools 110 add descriptive information to the travel listing with details about the modes of operation such as boarding information, seating, and amenities, for example. The reservation inquiry tools 112 handle acquiring such information as the user's or potential passenger's name, address, telephone number, payment information, number of passengers, one way/roundtrip, and other appropriate information relative to a reservation. The reservation verification tools 114 present an interface for the user or potential passenger to verify this information. The reservation confirmation tools 116 execute the reservation and provide the necessary confirmation. The financial transaction tools 118 work with an appropriate financial transaction server to complete all needed financial transactions. As will be appreciated, the reservation confirmation tools 116 and financial transaction tools 118 work in combination together. The accounting application manager 120 handles communication with an accounting application 150 (see FIG. 5).

In the illustrated embodiment, FIG. 4 also includes an operating system 130 that includes input device drivers 132 and a display module 134. In some embodiments, as illustrated, the device drivers 132 and display module 134 are part of the operating system 130 even when the image editing application is an application separate from the operating system. The input device drivers 132 may include drivers for translating signals from a keyboard, mouse, touchpad, tablet, touch screen, gyroscope, accelerometer, etc. A user interacts with one or more of these input devices, which send signals to their corresponding device driver. The device driver then translates the signals into user input data that is provided to the UI interaction and generation module 102.

FIG. 5 conceptually illustrates the software architecture of the accounting application 150 of some embodiments that may determine the fees 28 due to the various fee collecting entities 22 based on the transportation reservation 34. In some embodiments, the accounting application 150 is a stand-alone application or is integrated into another application such as the accounting application manager 120 of the reservation application 100 of FIG. 4, while in other embodiments the accounting application 150 might be implemented within an operating system.

Furthermore, in some embodiments, the accounting application 150 is provided as part of a server-based solution or a cloud-based solution. In some such embodiments, the application is provided via a thin client. That is, the application runs on a server while a user interacts with the application via a separate machine remote from the server. In other such embodiments, the application is provided via a thick client. That is, the application is distributed from the server to the client machine and runs on the client machine.

The accounting application 150 includes a user interface (UI) interaction and generation module 152, management (user) interface modules 154, entity management modules 156, transportation management modules 158, reservation management modules 159, network flow modules 160, analysis modules 162, report modules 164, fee distribution tools 166, and a reservation application manager 168. The management (user) interface modules 154 provide the software by which the user and a computer system, such as the server 12, interact within the system 10. The entity management modules 156 have access to the entity data 16 and manage the entity database 16. The transportation management modules 158 have access to the transportation data 18 and manage the transportation database 18. The reservation management modules 159 have access to the reservation database 20 and manage the reservation database 20. The network flow modules 160 analyze the entity database 16 and the transportation database 18 to develop the network flow model, which is analyzed by the analysis modules 162. The report modules 164 prepare various routine and custom reports for the users. The fee distribution tools 166 ensure the appropriate fees are distributed to the fee collecting entities. The reservation application manager 168 provides the interface for the accounting application 150 to the reservation application 100. Presentation instructions 170 store the user presentation editing operations that the accounting application 150 performs as a set of instructions. In some embodiments, the entity database 16, the transportation database 18, the reservation database 20, and the presentation instructions 170 are all stored in one physical storage. In other embodiments, the storages represented by the entity database 16, the transportation database 18, the reservation database 20, and the presentation instructions 170 are all stored in separate physical storages, or one of the storages is in one physical storage while the other is in a different physical storage.

In the illustrated embodiment, FIG. 5 also includes an operating system 180 that includes input device driver(s) 182 and a display module 184. In some embodiments, as illustrated, the input device drivers 182 and display module 184 are part of the operating system 180 even when the image editing application is an application separate from the operating system 180. The input device drivers 182 may include drivers for translating signals from a keyboard, mouse, touchpad, tablet, touch screen, gyroscope, accelerometer, etc. A user interacts with one or more of these input devices, which send signals to their corresponding device driver. The device driver then translates the signals into user input data that is provided to the UI interaction and generation module 152.

FIG. 6 illustrates an exemplary method for procuring a reservation using the system 10. The method starts at block 200 and at decision block 202 the methodology may handle management of the database with attributes or handle the procurement of a reservation by a passenger. At block 204, various agreements between the operator of the system and the fee collecting entities are received and following analysis of the agreements, the databases are appropriately populated with attributes at block 206. The network flow model is then maintained at block 208 before an updated cost surface is created at block 210. The methodology then returns to decision block 202.

At decision block 202, with respect to procurement of the reservation by the passenger, the methodology advances to block 212, where the server receives a travel availability request from the passenger. As alluded above, the travel request may be communicated over the Internet from a passenger at a smart device or a computer, may be received at call center from a user of a telephone, or may be received by the server in any other appropriate manner. Again, all references below to the communication through a network between the passenger—or someone, including people as well as partially and fully automated systems, making the reservation on behalf of the passenger—and server apply equally to communications between server and an operator at call center and communications between the operator and a user of a telephone. The travel availability request may include one or more parameters that a reservation must meet, such as a location, dates of availability, travel accommodation, or any other suitable parameters. At block 214, the server determines one or more available reservations that meet the parameters of the request by accessing information stored in the inventory databases. If the server determines at decision block 216 that no reservations meet the parameters, then the server communicates a message to the passenger at block 218 indicating that no travel arrangements meeting the request are available. The method may then return to the decision block 202 where the server may allow the passenger to try another search, for example.

If the server determines at decision blocks 220 and 222 that the requested reservation meets the parameters of the request, then the server communicates a list of available reservations with travel accommodations to the passenger. At block 224, the server receives the passenger information and processes the passenger information to create the reservation at block 226. The finalized reservation information is then communicated at block 228. A non-optimized cost path analysis is performed at block 230 based on the finalized reservation. At block 232, the fees due to various fee collecting entities are determined. At block 234, the system may verify that the reservation was utilized before setting any fees to be sent at block 236. The methodology then ends at block 238.

The present application describes a system 10 that provides users, such as potential passengers or reservation specialists, for example, with a platform for procuring reservations within a heterogeneous transportation network T, including multiple modes of transportation, T₁ . . . Tₙ, requiring coordinating many distinct arrangements for a single itinerary. The computer-based solution improves the quality and quantity of information about reservations for single itinerary through varying juristic and governmental boundaries by ensuring various entities, such as juristic and governmental entities, collect any required fees 28. The present application describes a system 10 that coordinates plural reservations, e.g. plural trip segments, and the payment of associated fees 28 by providing route searching, route guidance, and multimodal routing, i.e., combining two or more modes of transportation, where the modes can be any of form.

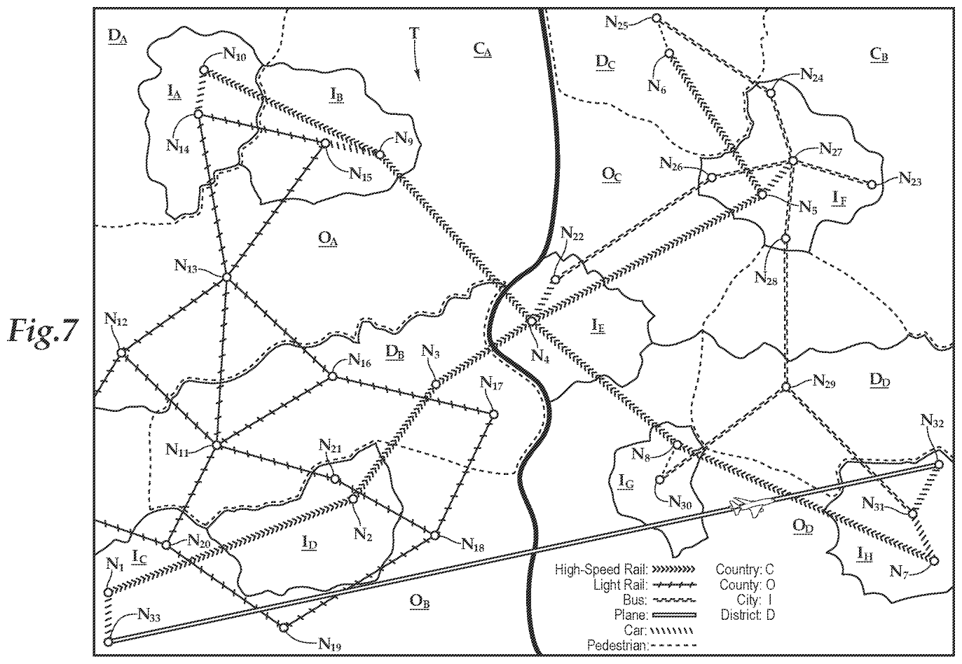

Embodiments according to the teachings presented herein will now be illustrated by reference to the following non-limiting working examples wherein modes of transportation and entity boundaries are solely representative of those which can be employed and are not exhaustive of those available and operative. Referring now to FIG. 7, the heterogeneous transportation network T shown in FIG. 1 is depicted in additional detail. With respect to fee collecting entities 22, as indicated in the legend to FIG. 7, countries C (i.e., C_{A}, C_{B}), counties O (i.e., O_{A}, O_{B}, O_{C}, O_{D}), cities I (i.e., I_{A}, I_{B}, I_{C}, I_{D}, I_{E}, I_{F}, I_{G}, I_{H}), and districts D (i.e., D_{A}, D_{B}, D_{C}, D_{D}) are depicted. The countries C, counties O, and cities I are examples of governmental fee collecting entities and the districts D are examples of juristic fee collecting entities. As shown various modes of transportation, such as high-speed rail, light rail, bus, plane, car (including autonomous vehicle and semi-autonomous vehicle), and pedestrian, traverse the countries C (i.e., C_{A}, C_{B}), counties O (i.e., O_{A}, O_{B}, O_{C}, O_{D}), cities I (i.e., I_{A}, I_{B}, I_{C}, I_{D}, I_{E}, I_{F}, I_{G}, I_{H}), and districts D (i.e. D_{A}, D_{B}, D_{C}, D_{D}). The various forms of transportation have transportation nodes N (i.e., N₁, N₂, N₃, N₄, N₅, N₆, N₇, N₈, N₉, N₁₀, N₁₁, N₁₂, N₁₃, N₁₄, N₁₅, N₁₆, N₁₇, N₁₈, N₁₉, N₂₀, N₂₁, N₂₂, N₂₃, N₂₄, N₂₅, N₂₆, N₂₇, N₂₈, N₂₉, N₃₀, N₃₁, N₃₂, N₃₃) representing possible origins, destinations, and intermediate points for passengers.

Example I. A passenger procures a reservation to travel from N₂₂ to N₂₃ within City I_{F}. (see FIG. 7) via bus. The ticket cost is $10 and the City I_{F} has an agreement in place to collect a quarter cent sales tax (0.0025). The following table, Table I, shows the calculation of the fee for Example I.

TABLE I
Fee Calculation for Example I

| | GIS-based | Valueless | Value-Based | |
|---|---|---|---|---|
| Entity | Attribute | Coefficient | Coefficient | Fee |
| I_{F} | N₂₂ to N₂₃ | 0.0025 | $10.00 | $0.025 |

Example II. A passenger procures a reservation to travel from N₉ to N₁₃ from City I_{B} to a location in County O_{A} (see FIG. 7). The ticket cost is $20 and the City I_{B} has an agreement in place to collect a quarter cent sales tax (0.0025) and the County O_{A} has an agreement in place to collect a transaction fee of $0.01. The following table, Table II, shows the calculation of the fee for Example II.

TABLE II
Fee Calculation for Example II

| | GIS-based | Valueless | Value-Based | |
|---|---|---|---|---|
| Entity | Attribute | Coefficient | Coefficient | Fee |
| I_{B} | N₉ to N₁₅ | 0.0025 | $20.00 | $0.025 |
| | N₁₅ to (N₁₃) | | | |
| O_{A} | (N₁₅) to N₁₃ | 1 | $0.01 | $0.01 |

Example III. A passenger procures a reservation to travel from N₂ to N₃₁, that is from City I_{D} within Country C_{A} to a location in City I_{H} within County O_{B} (see FIG. 7). The reservation includes high-speed rail (N₂ to N₁), transportation-for-hire (N₁ to N₃₃), plane (N₃₃ to N₃₂), and transportation-for-hire (N₃₂ to N₃₁). The ticket cost is $1,000 and several agreements govern the payment of fees. The City I_{B} has an agreement in place to collect a quarter cent sales tax (0.0025) and the City I_{C} has an agreement in place to collect a quarter cent sales tax (0.0025) also. The Country C_{A} has an exit fee of $2 per passenger and the Country C_{B} has an entry fee of $5 per passenger. The City I_{H} has a right of way agreement in place to collect a transaction fee of $0.01. The following table, Table III, shows the calculation of the fee for Example III.

TABLE III
Fee Calculation for Example III

| | GIS-based | Valueless | Value-Based | |
|---|---|---|---|---|
| Entity | Attribute | Coefficient | Coefficient | Fee |
| I_{D} | N₂ to (N₁) | 0.0025 | $1,000.00 | $0.056 |
| | | | prorated to | |
| | | | $20.00 | |
| I_{C} | (N₂) to N₁ | 0.0025 | $1,000.00 | $0.112 |
| | N₁ to N₃₃ | | prorated to | |
| | | | $40.00 | |
| C_{A} | N₃₃ to (N₃₂) | 1 | $2.00 | $2.00 |
| C_{B} | (N₃₂) to N₃₃ | 1 | $5.00 | $5.00 |
| I_{D} | N₂ to (N₁) | 1 | $0.01 | $0.01 |

Example IV. A passenger procures a reservation to travel from N₁ to N₆, that is from County O_{B} within Country C_{A} to a location in District D_{C} City I_{H} within County O_{B} (see FIG. 7). The reservation includes high-speed rail (N₁ to N₂ to N₃ to N₄ to N₅ to N₆). The ticket cost is $500 and several agreements govern the payment of fees. The District O_{B} has an agreement in place to collect a tax (0.000025) based on the value of the property and the City I_{C} and the City I_{D} have an agreement in place to collect a quarter cent sales tax (0.0025). The District D_{B} has an agreement in place to collect a use fee. The Country C_{A} has an exit fee of $2 per passenger and the Country C_{B} has an entry fee of $5 per passenger. The City I_{E} has a right of way agreement in place to collect a transaction fee of one percent. The County O_{C} collects a use fee of $0.50 per passenger. The City I_{F} collects a quarter cent sales tax (0.0025) and the District D_{C} collects a one percent bond repayment. The following table, Table IV, shows the calculation of the fee for Example IV.

TABLE IV
Fee Calculation for Example IV

| | GIS-based | Valueless | Value-Based | |
|---|---|---|---|---|
| Entity | Attribute | Coefficient | Coefficient | Fee |
| O_{B} | N₁ to (N₂) | 0.000025 | $100,000.00 | $2.50 |
| I_{C} | N₁ to (N₂) | 0.0025 | $500.00 prorated | $0.125 |
| | | | to $50.00 | |
| I_{D} | (N₁) to N₂ | 0.0025 | $500.00 prorated | $0.1875 |
| | to (N₃) | | to $75.00 | |
| D_{B} | N₃ | 1 | $5 | $5 |
| C_{A} | N₃ to (N₄) | 1 | $2.00 | $2.00 |
| C_{B} | (N₃) to N₄ | 1 | $5.00 | $5.00 |
| I_{E} | (N₃) to N₄ | 0.01 | $500.00 prorated | $0.75 |
| | to (N₅) | | to $75.00 | |
| O_{C} | (N₄) to | 50 | $0.50 | $25.00 |
| | (N₅) | | | |
| I_{F} | (N₄) to N₅ | 0.0025 | $500.00 prorated | $0.125 |
| | to (N₆) | | to $50.00 | |
| D_{E} | (N₅) to N₆ | 0.01 | $500 | $5.00 |

Example V. A passenger procures a reservation to travel from N₂₂ to N₂₃ within City I_{F} (see FIG. 7) via an unmanned autonomous vehicle providing an air taxi service. The ticket cost is $50 and the City I_{F} has an agreement in place to collect a quarter cent sales tax (0.0025). The following table, Table V, shows the calculation of the fee for Example V.

TABLE V
Fee Calculation for Example V

| | GIS-based | Valueless | Value-Based | |
|---|---|---|---|---|
| Entity | Attribute | Coefficient | Coefficient | Fee |
| I_{F} | N₂₂ to N₂₃ | 0.0025 | $50.00 | $0.125 |

Example VI. A passenger procures a reservation to travel from N₂₂ to N₂₃ within City I_{F} (see FIG. 7) via an unmanned autonomous vehicle providing an air taxi service. The ticket cost is $50 and the City I_{F} has an agreement in place to collect a quarter cent sales tax (0.0025) based on information collecte3d from an ADS-B system that monitors the taxi service. The following table, Table VI, shows the calculation of the fee for Example VI.

TABLE VI
Fee Calculation for Example VI

| | GIS-based | Valueless | Value-Based | |
|---|---|---|---|---|
| Entity | Attribute | Coefficient | Coefficient | Fee |
| I_{F} | N₂₂ to N₂₃ to | 0.0025 | $50.00 | $0.375 |
| | N₂₂ to N₂₃ | | | |
| | per ADS-B | | | |

The present working examples described in Example I through Example VI demonstrate a system and a method that coordinates plural reservations, e.g. plural trip segments, while ensuring the payment of associated fees due to various fee collecting entities. In this manner, the systems and methods presented herein enable a single reservation purchase as appropriate fee distribution is ensured.

The order of execution or performance of the methods and data flows illustrated and described herein is not essential, unless otherwise specified. That is, elements of the methods and data flows may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A system for procuring a reservation within a heterogeneous transportation network, the system comprising:
a database within a computer data storage device for storing and organizing information for a plurality of transportation modes within the heterogeneous transportation network, the plurality of transportation modes forming a plurality of transportation routes, the information being organized within the database in accordance with a logical data model including a plurality of fee collecting entities, and relationships defining the manner in which the information is stored and organized in the logical data model including, for each of the plurality of fee collecting entities for each of the plurality of transportation modes:
a first attribute including GIS data defining a virtual perimeter for a real-world geographic area corresponding to the fee collecting entity,
a second attribute including a valueless coefficient defining a payment term for the fee collecting entity, and
a third attribute including a value-based coefficient defining a payment basis for the fee collecting entity;
a user interface module that provides a user interface on a computing device, the user interface providing functionality for a user to at least browse reservation information within the heterogeneous transportation network and select a transportation reservation, the transportation reservation including at least one of the plurality of transportation routes; and
non-transitory memory accessible to a processor, the non-transitory memory including processor-executable instructions that, when executed, by the processor cause the system to:
receive confirmation of the transportation reservation including at least one of the plurality of transportation routes,
access the computer data storage device, and
analyze for each of the plurality of fee collecting entities for the transportation reservation, a fee due to the fee collecting entity based on the first attribute, the second attribute, and the third attribute.

2. The system as recited in claim 1, wherein the plurality of transportation modes further comprises high-speed rail.

3. The system as recited in claim 1, wherein the heterogeneous transportation network further comprises transportation modes selected from the group consisting of high-speed rail, light rail, streetcar, transportation-for-hire, autonomous vehicles, semi-autonomous vehicles, and bus.

4. The system as recited in claim 1, wherein the plurality of fee collecting entities further comprise juristic entities.

5. The system as recited in claim 1, wherein the plurality of fee collecting entities further comprise governmental entities.

6. The system as recited in claim 1, wherein for each of the plurality of fee collecting entities, the first attribute, the second attribute, and the third attribute are defined by contract.

7. The system as recited in claim 1, wherein the first attribute further comprises a nodal data of passenger exchange locations.

8. The system as recited in claim 7, wherein the network flow model further comprises a plurality of nodes interconnected with a plurality of arcs, each of the plurality of arcs being a portion of the plurality of transportation routes.

9. The system as recited in claim 1, wherein the second attribute further comprises a value relative to the group consisting of a sales tax, a property tax, and a transaction payment.

10. The system as recited in claim 1, wherein the third attribute further comprises a value relative to the group consisting of a ticket price and a property value.

11. The system as recited in claim 1, wherein the processor-executable instructions that, when executed, by the processor cause the system to analyze for each of the plurality of fee collecting entities for the transportation reservation, a fee due to the fee collecting entity based on the first attribute, the second attribute, and the third attribute, further comprise processor-executable instructions that, when executed, by the processor cause the system to create a network flow model based on the first attribute.

12. The system as recited in claim 1, wherein the processor-executable instructions that, when executed, by the processor cause the system to analyze for each of the plurality of fee collecting entities for the transportation reservation, a fee due to the fee collecting entity based on the first attribute, the second attribute, and the third attribute, further comprise processor-executable instructions that, when executed, by the processor cause the system to create a cost surface having a plurality of cells, the cost surface having a value in each of the plurality of cells relative to the second attribute.

13. The system as recited in claim 1, wherein the processor-executable instructions that, when executed, by the processor cause the system to analyze for each of the plurality of fee collecting entities for the transportation reservation, a fee due to the fee collecting entity based on the first attribute, the second attribute, and the third attribute, further comprise processor-executable instructions that, when executed, by the processor cause the system to create a cost surface having a plurality of cells, the cost surface having a value in each of the plurality of cells relative to the second attribute and a weight associated with each of the plurality of cells relative to the third attribute.

14. The system as recited in claim 1, wherein the processor-executable instructions that, when executed, by the processor cause the system to analyze for each of the plurality of fee collecting entities for the transportation reservation, a fee due to the fee collecting entity based on the first attribute, the second attribute, and the third attribute, further comprise processor-executable instructions that, when executed, by the processor cause the system to perform a non-optimized cost path analysis reflecting the transportation reservation.

15. The system as recited in claim 1, wherein the processor-executable instructions that, when executed, by the processor cause the system to analyze for each of the plurality of fee collecting entities for the transportation reservation, a fee due to the fee collecting entity based on the first attribute, the second attribute, and the third attribute, further comprise processor-executable instructions that, when executed, by the processor cause the system to perform a non-optimized cost distance analysis reflecting the transportation reservation.

16. The system as recited in claim 1, wherein the processor-executable instructions that, when executed, by the processor cause the system to analyze for each of the plurality of fee collecting entities for the transportation reservation, a fee due to the fee collecting entity based on the first attribute, the second attribute, and the third attribute, further comprise processor-executable instructions that, when executed, by the processor cause the system to perform cartographic modeling.

17. A system for procuring a reservation within a heterogeneous transportation network, the system comprising:
a database within a computer data storage device for storing and organizing information for a plurality of transportation modes within the heterogeneous transportation network, the plurality of transportation modes forming a plurality of transportation routes, the information being organized within the database in accordance with a logical data model including a plurality of fee collecting entities, and relationships defining the manner in which the information is stored and organized in the logical data model including, for each of the plurality of fee collecting entities for each of the plurality of transportation modes:
a first attribute including GIS data defining a virtual perimeter for a real-world geographic area corresponding to the fee collecting entity,
a second attribute including a valueless coefficient defining a payment term for the fee collecting entity, and
a third attribute including a value-based coefficient defining a payment basis for the fee collecting entity;
a user interface module that provides a user interface on a computing device, the user interface providing functionality for a user to at least browse reservation information within the heterogeneous transportation network and select a transportation reservation, the transportation reservation including at least one of the plurality of transportation routes; and
non-transitory memory accessible to a processor, the non-transitory memory including processor-executable instructions that, when executed, by the processor cause the system to:
receive confirmation of the transportation reservation including at least one of the plurality of transportation routes,
access the computer data storage device,
create a network flow model based on the first attribute,
create a cost surface having a plurality of cells, the cost surface having a value in each of the plurality of cells relative to the second attribute and a weight associated with each of the plurality of cells relative to the third attribute,
perform a non-optimized cost path analysis on the cost surface reflecting the transportation reservation, and
determine a fee due to the fee collecting entity.

18. The system as recited in claim 17, wherein the heterogeneous transportation network further comprises transportation modes selected from the group consisting of high-speed rail, light rail, streetcar, transportation-for-hire, autonomous vehicle, semi-autonomous vehicle, and bus.

19. The system as recited in claim 17, wherein the plurality of fee collecting entities further comprise entities selected from the group consisting of juristic entities and governmental entities.

20. A system for procuring a reservation within a heterogeneous transportation network, the system comprising:
a database within a computer data storage device for storing and organizing information for a plurality of transportation modes within the heterogeneous transportation network, the plurality of transportation modes forming a plurality of transportation routes, the information being organized within the database in accordance with a logical data model including a plurality of fee collecting entities, and relationships defining the manner in which the information is stored and organized in the logical data model including, for each of the plurality of fee collecting entities for each of the plurality of transportation modes:
a first attribute including GIS data defining a virtual perimeter for a real-world geographic area corresponding to the fee collecting entity,
a second attribute including a valueless coefficient defining a payment term for the fee collecting entity, and
a third attribute including a value-based coefficient defining a payment basis for the fee collecting entity;
a user interface module that provides a user interface on a computing device, the user interface providing functionality for a user to at least browse reservation information within the heterogeneous transportation network and select a transportation reservation, the transportation reservation including at least one of the plurality of transportation routes; and
non-transitory memory accessible to a processor, the non-transitory memory including processor-executable instructions that, when executed, by the processor cause the system to:
receive confirmation of the transportation reservation including at least one of the plurality of transportation routes,
access the computer data storage device,
create a network flow model based on the first attribute,
create a cost surface having a plurality of cells, the cost surface having a value in each of the plurality of cells relative to the second attribute and a weight associated with each of the plurality of cells relative to the third attribute,
perform a non-optimized cost path analysis using cartographic modeling on the cost surface reflecting the transportation reservation, and
determine a fee due to the fee collecting entity.
